(19) United States
(12) Patent Application Publication
(10) Pub. No.: US 2007/0249308 A1
(43) Pub. Date: Oct. 25, 2007

(54) Method and apparatus for uplink coverage improvement

(75) Inventors: Shiwei Gao, Nepean (CA); Hafedh Trigui, Ottawa (CA)

Correspondence Address: Lawrence G. Kurland, Esq.;BRYAN CAVE LLP, 1290 Avenue of the Americas, New York, NY, 10104-3300, US

(73) Assignee: TenXc Wireless Inc.

(21) Appl. No.: 11/784,103

(22) Filed: Apr. 4, 2007

(30) Foreign Application Priority Data
Apr. 4, 2006 (CA) 2,547,649

(51) Int. Cl. H04B 17/02; H04B 1/06; H04M 1/00

(52) U.S. Cl. 455/137; 455/562.1; 455/273

(57) ABSTRACT

A method and apparatus for an uplink signal processing system that includes converting a plurality of received RF signals which can be grouped by common diversity characteristics into the digital domain, and performing signal processing on the signals to maximize the signal to noise ratio, when the signals common to a diversity characteristic are combined. The signals are then combined and converted back to RF, to conventionally provide a base station with a main and diversity channel.

### CROSS REFERENCE TO RELATED APPLICATIONS

This application claims the benefit of Canadian Application Serial No. 2,547,649, filed Apr. 4, 2006, which disclosure is incorporated herein by reference in its entirety.

### FIELD OF THE INVENTION

The present invention relates to a method and apparatus for improving uplink coverage from a base station, more particularly to a method and apparatus for performing low-loss signal combining in the digital domain.

### BACKGROUND TO THE INVENTION

In a wireless cellular system, the coverage of a base station is typically limited by the ability of the mobile stations (i.e. cell-phones, mobile handsets) to communicate to the base station, commonly known in the industry as uplink communication. This limitation is due to the limited transmission power of the mobile stations.

One approach to increase the uplink signal strength is to increase power at the mobile handsets. However, this would not be appealing to users, as it would increase the size of mobile handsets and/or decrease their battery life.

Other approaches traditionally used to improve the uplink coverage includes using two-branch receive diversity in the base transceiver stations (BTS) and providing a Tower-top Low Noise Amplifier (TLNA).

The two-branch diversity scheme consists of using signals from antennas that are differentiated by some diversity characteristic, such as polarization or space.

This scheme improves the receiver performance by combining the signals together to mitigate deep fading of the received signal. Two branch receive diversity typically provides 5 dB in signal to noise ratio (SNR) gain.

A TLNA is an amplifier placed at the top of the base station tower to avoid SNR degradation from RF feeder cable losses between the antennas and the base station. Use of a TLNA typically provides an SNR improvement of about 3 dB.

However, because a TLNA is an active component, electrical power will have to be provided at the top of the base station towers. This introduces concerns with reliability, maintenance and cost.

It is known to use multiple antennas such as quadpole antennas (two cross-polarized antennas side by side in the same housing) to avoid combiner loss in the transmit (downlink) direction, to support multiple RF carriers. However, in the receive (uplink) direction, only two antennas/diversity branches are generally used, which reduces to two-branch diversity as discussed above.

### SUMMARY OF THE INVENTION

Accordingly, it is desirable to provide a method and system for improving the link budget in the uplink direction.

It is further desirable to provide a system and method that can be easily integrated into existing systems without involving tower-top electronics.

It is still further desirable to provide a system and method that can be deployed without alteration to the downlink system.

The present invention accomplishes these aims by providing a system which combines the signals from a plurality of antennas corresponding to a common diversity characteristic in a manner that optimizes the overall signal strength, while still providing support for two-branch diversity.

The present invention has been found to make an improvement of up to 6 dB over a conventional two-branch diversity scheme for typical deployment scenarios. Higher gains could conceivably be achieved if more antennas are available.

In accordance with a first broad aspect of the present invention, there is disclosed a method of combining signals in the receive path of a wireless communications system, comprising the steps of receiving a plurality of RF signals corresponding to a common diversity characteristic through a plurality of corresponding antenna elements; converting the received RF signals into electronic digital signals; and combining the converted signals into composite signals representative of the diversity characteristic; wherein the step of combining is optimized for signal quality.

In accordance with a second broad aspect of the present invention, there is disclosed a receiver system for wireless communications, comprising a plurality of analog to digital converters each adapted to be coupled to a corresponding antenna element for receiving RF signals corresponding to a common diversity characteristic for converting the received RF signals into digital signals; and an optimizing combiner coupled to the analog to digital converters for combining the digital signals into a composite signal representative of the diversity characteristic; wherein the optimizing combiner combines the signals in such a manner that they are optimized for signal quality.

In accordance with a third broad aspect of the present invention, there is disclosed an RF signal processor, comprising: a plurality of input ports for receiving antenna signals corresponding to a common diversity characteristic; at least one analog to digital converter coupled to said input ports for transforming the antenna signals into digital form; and an optimizing combiner coupled to the at least one analog to digital converter for combining the digital signals into a composite signal representative of a common diversity characteristic; wherein the optimizing combiner combines the signals in such a manner that they are optimized for signal quality.

### BRIEF DESCRIPTION OF THE DRAWINGS

The embodiments of the present invention will now be discussed by reference to the following figures, in which identical reference numerals in different figures indicate identical elements and in which:

FIG. 1 is a block diagram illustrating the integration of the present invention as an appliqué system into an existing base station; and

FIG. 2 is a block diagram of the present invention.

### DETAILED DESCRIPTION OF THE PREFERRED EMBODIMENT

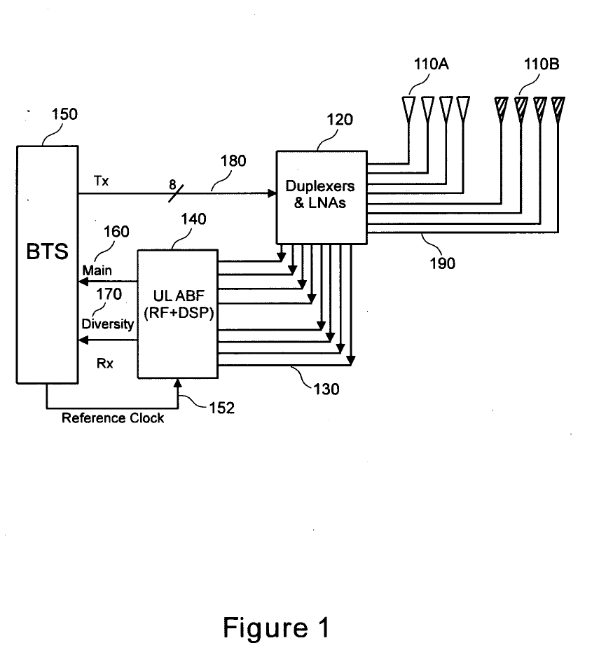

FIG. 1 is a block diagram illustrating the integration of the present invention as an appliqué system into an existing base station 150. An appliqué system is generally known in the art as a system that is applied to the inputs of an existing system in order to extract some type of performance improvement, without modifying the existing system.

In an exemplary embodiment, the present invention consists of eight antennas 110, eight RF feeder cables 190, a plurality of duplexers and low noise amplifiers (LNA) 120, a Radio Frequency (RF) and Digital Signal Processor (DSP) processing block 140, and the base station (BTS) 150.

The antennas 110 are connected to the duplexers and LNAs 120 through the RF feeder cables 190.

The duplexers and LNAs 120 are connected to the RF and DSP processing block 140, through connections 130. The duplexers and LNAs 120 receive signals from the base station 150 through connections 180. The duplexers and LNAs 120 are connected to the antennas 110, through the RF feeder cables 190.

The RF and DSP processing bock 140 is connected to the base station 150 through the main 160 and diversity 170 receive channels. The RF and DSP processing block 140 also receives a reference clock signal 152 from the base station 150. It also receives signals through connections 130 from the duplexers and LNAs 120.

The base station 150 sends transmission signals through connections 180 to the duplexers and LNAs 120, and a reference clock 152 to the RF and DSP processing block 140. It receives the main channel 160 and the diversity channel 170 from the RF and DSP processing block 140.

There are eight antennas 110 in the exemplary embodiment, shown as two sets, 110A, 110B of diversity characteristics in the form of polarizations. The first set 110A each have a +45° polarization, and the second set 110B have −45° polarizations as shown. Other embodiments could include more or less antennas, and have other sets of common diversity characteristics as would be known to a person skilled in the art. The antennas 110 receive and transmit data to and from a mobile station.

The duplexers and LNAs 120 filter and amplify signals being received/transmitted by the antennas 110 in conventional fashion. The duplexers allow the transmission and reception of signals on the same antenna at the same time, and reject unwanted signals. The LNAs 120 amplify signals being transmitted and received by the antennas 110. In the exemplary embodiment the duplexers and LNAs 120 are located on the ground in the proximity of the base station 150, thus obviating any need for power to be delivered to the rooftop.

The RF and DSP processing block 140 is provided to down-convert and digitize the received signals arriving along connections 130. It provides digital signals for digital signal processing, including digital filtering to extract individual RF channels, and the optimized combination of the received signals. In order to be able to provide both main 160 and diversity 170 channels for two-branch diversity as expected by the base station 150, the signals for each RF channel are divided into two groups based on their diversity characteristic, for example, as in the exemplary embodiment, polarization, and combined by the RF and DSP processing block 140 to provide the main 160 and diversity channels 170.

The combination of the received signals by the RF and DSP processing block 140 optimizes the output signal according to a desired performance metric.

The base station (BTS) 150 is a conventional base station as is known in the art. It is provided to manage the flow of communication from the client mobile station (not shown) to another communication station (not shown) that may be a mobile station or a wire-based communication station (such as a telephone).

Additionally, the base station 150 provides a reference clock 152 to the RF and DSP processing block 150, to assist in the synchronization of the main 160 and diversity channels 170 being communicated, in conventional fashion.

In a downlink or forward communication, signals from the base station 150 are conventionally sent through connections 180 to the duplexers and LNAs 120. In the exemplary embodiment the base station supports eight RF signals, and each of the RF signals is transmitted to the duplexers and LNAs 120 through connections 180.

The duplexers and LNAs 120 receive the transmission signals from the base station through connections 180. The received transmission signals are filtered, amplified, and then sent through the RF feeder cables 190 to their respective antennas 110.

The antennas 110, corresponding to each RF signal, then transmit the filter and amplified signal to the appropriate mobile station (not shown).

In an uplink or reverse communication, eight antennas 110 receive signals transmitted from a mobile station (not shown) each corresponding to one of two diversity characteristics such as polarization. The received signals are sent to the duplexers and LNAs 120 through the RF feeder cables 190.

The duplexers and LNAs 120 receive the received signals from the RF feeder cables 190. The received signals are filtered and amplified, and then forwarded to the RF and DSP processing block 140 through connections 130.

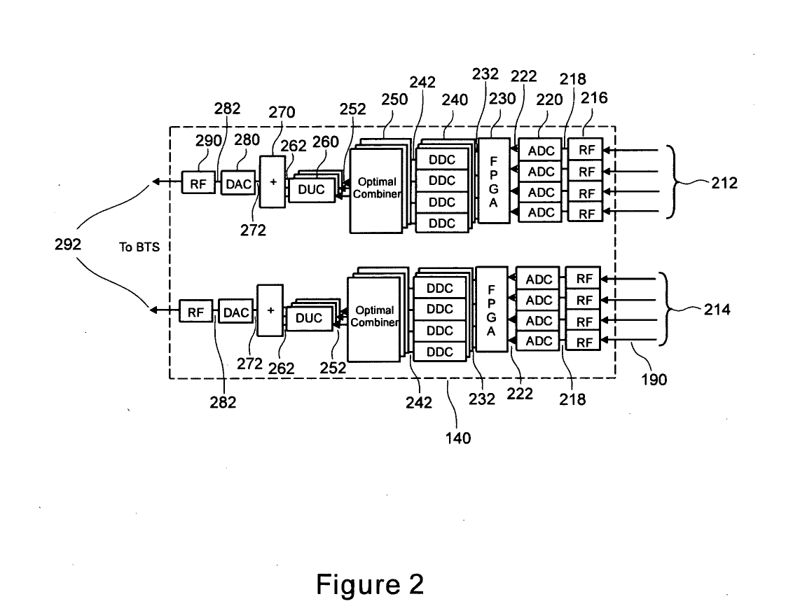

The RF and DSP processing block 140 receives the filtered and amplified signals from the duplexers and LNAs 120 through the connections 130. The filter and amplified signals are thereafter down-converted, digitized, and digital signal processing is performed as shown in greater detail in FIG. 2 and discussed below. In particular, only those RF channels serviced by the base station 150 are extracted for processing.

Those having ordinary skill in this art will readily recognize that not all RF channels received by the antennas 110 will be supported by the base station 150. For example, in the preferred Global System for Mobile Communications (GSM) embodiment, an RF channel is defined as comprising a designated radio frequency with an associated 200 kHz bandwidth and is assigned an Absolute Radio Frequency Channel Number (ARFCN). An RF channel with ARFCN=1 refers to the pre-defined RF channel from 890 MHz to 890.2 MHz in the uplink direction and from 935 MHz to 935.2 Mhz in the downlink direction. (Although GSM is a frequency duplex system so that each channel needs a pair of frequencies, one for each direction, in the present invention, only the uplink channels are of interest.)

Thus a base station 150 may typically only support a small subset (eg. a maximum of 12) of the available RF channels (which may be 100 if the receiver bandwidth is 20 MHz in the preferred GSM embodiment) at any given time.

In the exemplary embodiment, eight signals are shown in FIG. 1, however those having ordinary skill in the art will readily recognize that any number, greater than two, could be used in the context of the present invention.

In order to be able to provide both main 160 and diversity 170 channels for two-branch diversity as expected by the base station, the signals for each RF channel, corresponding to each of the signals received by one of the antennas 110, are divided into two groups based on their diversity characteristic.

Upon completion of the processing the RF and DSP processing block 140 the received signals have been combined based on the diversity characteristics, into main 160 and diversity 170 channels. The main 160 and diversity channels 170 are then forwarded to the base station 150. The base station 150 receives the main 160 and diversity 170 channels. The base station then performs conventional communication processing on the main 160 and diversity 170 channels.

Turning now to FIG. 2, there is shown a block diagram of the RF and DSP processing block 140 embodying the present invention. The diagram shows the RF feeder cables 190 entering the RF and DSP processing block 140. In the exemplary embodiment, these carry antenna signals having different diversity characteristics. In the exemplary embodiment four antenna signals 212 have +45° polarization and four antenna signals 214 have −45° polarizations.

The RF and DSP processing block 140 comprises a plurality (corresponding to the number of antenna signals) of RF converters 216, analog to digital converters (ADCs) 220, protocol processors 230, digital down converters (DDCs) 240, optimal combiners 250, and digital up-converters (DUCs) 260, and two each of multiplexers 270, digital to analog converters (DACs) 280, and RF converters 290 corresponding to each diversity characteristic.

Each RF converter 216 receives an antenna signal 212 or 214, along its associated corresponding RF feeder cable 190 and converts its antenna signal 212 or 214 into an intermediate frequency analog signal 218 that it outputs to its corresponding analog to digital converters 220 for further processing.

Each analog to digital converter (ADC) 220, receives the intermediate frequency analog signal 218 from its associated RF converter 216, converts the analog signal 218 into a digital signal 222 to permit digital signal processing, and forwards it to its corresponding protocol processor 230.

Each protocol processor 230 receives the digital signal 232 from its associated analog to digital converter (ADC) 220, processes it in accordance with the adapted protocol into a processed digital signal 232 and forwards it to its corresponding digital down converter (DDC) 240.

Each digital down converter (DDC) 240 receives the processed digital signal 232 from its associated protocol processor 230, converts the processed digital signal 232 down from the intermediate frequency to baseband for further processing down stream, filters it to select a desired frequency channel, decimates it according to the transmitted rate and forwards the resulting baseband signal 242 to the optimal combiner 250.

For the exemplary embodiment employing the GSM standard, the channel bandwidth is 200 kHz and the symbol rate is 13/48 Msps (mega symbols per second), so the sampling rate after decimation can be either 2 samples per symbol or 4 samples per symbol, ie. 13/24 mega samples per second or 13/12 mega samples per second.

While the RF and DSP processing block 140 is shown for a single RF channel for simplicity, those having ordinary skill in this art will readily appreciate that a plurality of RF channels may be processed by the base station 150. In such circumstances, a DDC 240 may process multiple RF channels. Alternatively, more than one channel may be supported by one or more of the RF 216 and analog to digital converter 220 circuit blocks. In such a case, multiple digital down converters 240 may be used after the corresponding digital down converter 240.

The optimal combiner 250 receives the baseband signal 242 from its associated digital down converter 240, calculates the optimal manner by which to combine the signals 242 to maximize signal quality and forwards a combined signal 252 to its corresponding digital up-converter 260.

For each exemplary GSM RF channel, there are two optimal combiners 250, each associated with one group of antennas 110 having a common polarization.

Preferably, the combining step implements a diversity combining method. In the exemplary embodiment, the antenna signals are combined in a manner that optimizes the output signal to noise ratio (SNR). Alternatively, signals could be combined to maximize the signal to noise plus interference ratio (SNIR). In either case the optimization implements the signal quality as measured by one of a number of mathematical methods including, but not limited to, the Maximum Ratio Combining (MRC) or Minimum Mean Square Error (MMSE) diversity combining techniques or other suitable combining technique as will be apparent to those having ordinary skill in this art.

An example of Maximum Ratio Combining (MRC) of two signals x₁(t) and x₂(t) is given by:
w₁x₁(t)+w₂x₂(t)=y(t) (1)
where
y(t) is the resulting signal combination; and
w₁ and w₂ are the signal weightings.
Each signal may be represented as:
   x₁(t)=A₁e^{+jθ}^{₁}·s(t)+n₁(t) (2)
   x₂(t)=A₂e^{+jθ}^{₂}·s(t)+n₂(t) (3)
   where
A is the amplitude response of the corresponding wireless propagation channel,
e^{jθ} is the phase portion of the channel response;
s(t) is the desired signal; and
n(t) is the receiver noise.
The MRC weightings are defined as:
   w₁=A₁e^{-jθ}^{₁} (4)
   w₂=A₂e^{-jθ}^{₂₆} (5)

In a real wireless system, A₁, θ₁, A₂, θ₂ are not available so that the weights W₁ and W₂ are estimated from the received signals x₁(t) and x₂(t). The optimal estimate of the weights satisfies the following equation

$$R \cdot [ \begin{matrix}{w}_{1} \\ {w}_{2}\end{matrix} ] = {λ}_{max} \cdot [ \begin{matrix}{w}_{1} \\ {w}_{2}\end{matrix} ] \qquad ( 6 )$$

where
R is the estimated covariance matrix of the received signals, and
λₘₐₓ is the maximum eigenvalue of R.
R is in turn defined by:

$$R = {\sum }_{i = 1}^{N} [ \begin{matrix}{x}_{1} ( {t}_{i} ) \\ {x}_{2} ( {t}_{i} )\end{matrix} ] \cdot {[ \begin{matrix}{x}_{1} ( {t}_{i} ) & {x}_{2} ( {t}_{i} )\end{matrix} ]}^{H} \qquad ( 7 )$$

where x(tᵢ) denotes the sample of x(t) at time tᵢ,
N is the number of samples used in the estimation, and
(•)^{H} is the complex transpose of a vector.

Thus

$$[ \begin{matrix}{w}_{1} \\ {w}_{2}\end{matrix} ]$$

is the eigenvector of R associated with eigen-value λₘₐₓ.

The above method can be easily extended to more than two received signals.

Each optimal combiner 250 in the exemplary embodiment solves the above equations to determine an optimal weight (w) for each signal, so as to maximize the signal to noise ratio. The weights are calculated at each GSM time slot for each RF channel. To reduce signal latency in an appliqué system due to the processing delay in calculating the weights, only a small number of the signal samples at the beginning of each GSM time slot are used for the weights calculation. The same number of samples, N, used for the weights calculation are used for every time slot and every RF channel.

Each digital up converter (DUC) 260 receives the combined signal 252 from its associated optimal combiner 250, interpolates and filters the signals to a higher sampling rate and converts the combined signal up from the baseband frequency to an intermediate frequency, which is unique to each RF channel and forwards an up-converted signal 262 to the multiplexer 270.

Each multiplexer 270 receives a plurality of up-converted signals 262 from its associated digital up-converter 260, combines these up-converter signals 262 corresponding to different RF channels and forwards the multiplexed signal 272 to the corresponding digital to analog converter 280. There are two multiplexers 270, each associated with one group of antennas having common polarization.

Each digital to analog converter (DAC) 280 receives the multiplexed signal 272 from its associated multiplexer 270, converts the multiplexed signal 272 from digital to analog form and forwards an analog signal 282 to its corresponding RF block 290.

The RF block 290 receives the analog signal 282 from its associated multiplexer 280, converts the analog signal 282 from an intermediate frequency to an RF signal for reception by the base station (not-shown) and generates an RF signal 292 corresponding to its associate diversity characteristic.

Thus, in operation, each antenna signal follows a parallel path according to its associated diversity characteristic. Initially, each path is separate from antenna 110 to the common associated multiplexer 270. A corresponding RF converter 216 receives one of these antenna signals 212, 214. The RF converter 216 then sends the processed signal to successively: an ADC 220 and protocol processor 230, digital down converter (DDC) 240 optimal combiner 250, digital up converter (DUC) 260 and multiplexer 270 through respective signals 218, 222, 232, 242, 252 and 262.

Each multiplexer 270 receives a plurality (in the exemplary embodiment, 4) of up-converted signals 262 corresponding to a common diversity characteristic, combines the up-converted signal 262 and forwards the resultant multiplexed signal 272 to its corresponding digital to analog converter (DAC) 280.

The digital to analog converters (DAC) 280 and RF converters 290 in turn convert the multiplexed signal 272 into analog form and at RF frequencies respectively, ultimately returning an analog RF signal 292 to the base station 150 that resembles, and would be indistinguishable to the base station 150 from, an antenna 110, except for the improved signal performance.

In the exemplary embodiment there are two such analog RF signals 292, each corresponding to either the main or diversity channels for the base station 150.

As such the present invention can be deployed as an appliqué system for existing networks, or as a plug and play device for a network installation.

The present invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific integrated circuits), FPGAs (field-programmable gate arrays) or DSPs (digital signal processors).

Examples of such types of computers are the optimal combiner 250 contained in the RF and DSP processing block 140, suitable for implementing or performing the apparatus or methods of the invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the present invention for which an exclusive property or privilege is claimed are:

1. A method of combining signals in the receive path of a wireless communications system, comprising the steps of:
(a) receiving a plurality of RF signals corresponding to a common diversity characteristic through a plurality of corresponding antenna elements;
(b) converting the received RF signals into electronic digital signals; and
(c) combining the converted signals into composite signals representative of the diversity characteristic;
wherein the step of combining is optimized for signal quality.

2. A method according to claim 1, further comprising the steps of:
(d) converting the converted composite signals into analog signals; and
(e) sending the signals to a base station.

3. A method according to claim 1, wherein the step of combining uses diversity combining.

4. A method according to claim 1, wherein the step of combining uses minimum mean square error.

5. A method according to claim 1, wherein the step of combining uses maximum ratio combining.

6. A method according to claim 1, further comprising the step of repeating steps (a) through (c) in respect of a second plurality of RF signals corresponding to a different common diversity characteristic.

7. A receiver system for wireless communications, comprising:
a plurality of analog to digital converters each adapted to be coupled to a corresponding antenna element for receiving RF signals corresponding to a common diversity characteristic for converting the received RF signals into digital signals; and
an optimizing combiner coupled to the analog to digital converters for combining the digital signals into a composite signal representative of the diversity characteristic;
wherein the optimizing combiner combines the signals in such a manner that they are optimized for signal quality.

8. A receiver system for wireless communications according to claim 7, further comprising:
digital to analog converters coupled to the optimizing combiner for converting the composite signals into an analog signal; and
an output port coupled to the digital to analog converters for sending the composite analog signal to a base station.

9. A receiver system for wireless communications according to claim 7, wherein said system is adapted to be interposed between the antenna elements and a base station.

10. A receiver system for wireless communications according to claim 7, wherein said optimizing combiner further comprises a diversity combiner.

11. A receiver system for wireless communications according to claim 10, wherein said optimizing combiner further comprises a maximum ratio combiner.

12. A receiver system for wireless communications according to claim 10, wherein said optimizing combiner further comprises a minimum mean square error combiner.

13. A receiving system for wireless communications according to claim 7, further comprising at least one additional plurality of antenna elements for receiving RF signals corresponding to a different common diversity characteristic, and corresponding analog to digital converters and optimizing combiner with respect to each additional plurality of antenna elements coupled thereto.

14. A receiver system for wireless communications according to claim 13, wherein the plurality of analog to digital converters numbers eight.

15. An RF signal processor, comprising:
a plurality of input ports for receiving antenna signals corresponding to a common diversity characteristic;
at least one analog to digital converter coupled to said input ports for transforming the antenna signals into digital form; and
an optimizing combiner coupled to the at least one analog to digital converter for combining the digital signals into a composite signal representative of a common diversity characteristic;
wherein the optimizing combiner combines the signals in such a manner that they are optimized for signal quality.

16. An RF signal processor according to claim 15, further comprising:
at least one digital to analog converter coupled to the optimizing combiner for converting the composite signal into an analog signal;
an output port coupled to the digital to analog converters for sending the composite analog signal to a base station.

17. An RF signal processor according to claim 15, wherein said optimizing combiner further comprises a diversity combiner.

18. An RF signal processor according to claim 15, wherein said optimizing combiner further comprises a maximum ratio combiner.

19. An RF signal processor according to claim 15, wherein said optimizing combiner further comprises a minimum mean square error combiner.

20. An RF signal processor according to claim 15, wherein there are eight antenna signals.

21. An RF signal processor according to claim 15, further comprising:
a plurality of groups of input ports for receiving antenna signals, each group corresponding to a group of antenna signals having a common diversity characteristic; and
an optimizing combiner coupled to the at least one analog to digital converter for combining each group of digital signals into composite signals representative of each group's common diversity characteristic.

22. An RF signal processor according to claim 21 further comprising:
at least one digital to analog converter coupled to the optimizing combiner for converting the composite signals into analog signals;
a plurality of output ports coupled to the digital to analog converters for sending the composite analog signals to a base station.

23. An RF signal processor according to claim 22, wherein the composite analog signals correspond to a main and diversity channel for a base station.
